(19) United States
(12) Patent Application Publication
(10) Pub. No.: US 2025/0172004 A1
(43) Pub. Date: May 29, 2025

(54) Tool for keeping plaster during plastering work and for scraping excess plaster off a trowel

(71) Applicant: Betri spadar ehf., Akureyri (IS)

(72) Inventors: Thorir Rafn Holmgeirsson, Akureyri (IS); Saevar Throstur Eysteinsson, Akureyri (IS)

(21) Appl. No.: 18/748,738

(22) Filed: Jun. 20, 2024

(30) Foreign Application Priority Data
Nov. 24, 2023 (IS) 50611

(51) Int. Cl. E04F 21/08

(52) U.S. Cl. CPC E04F 21/08

(57) ABSTRACT

A tool (1) for keeping a working amount of plaster and which allows the easy shaving-off excess plaster off a trowel and also picking up plaster with the trowel from the tool. The tool comprises an elongated compartment referred to as a trough (2), with longitudinal inner walls (4,4′) that extend from respective longitudinal straight edges (3,3′) to a V-shaped bottom, a grip portion (5) underneath the trough, and at least two feet (6,6′) on which the tool can rest with the trough facing upwardly such that the user can fit his hand under the grip to grip and lift the tool from its resting position. Preferably one or both of the edges (3,3′) are slanted from horizontal. The edges can be slanted in the same or opposite direction, to form a suitable angle of the edges (3,3′) for either or both a right-handed and left-handed user.

### RELATED APPLICATIONS

This application claims the benefit of Icelandic patent application No. 050611 filed on 24 Nov. 2023. The subject matter of this application is hereby incorporated by reference in its entirety.

### FIELD OF INVENTION

The invention is in the field of hand tools and specifically concerns tools for plastering work.

### TECHNICAL BACKGROUND

In the modern building industry plastering interior walls for finishing is a standard technique used worldwide. Interior walls and ceilings are commonly arranged with gypsum boards (drywall boards) where the joints between boards typically need plastering to obtain continuous surface with no visible board edges. Other types of walls such as concrete walls or brick walls may need surface plastering in order to have nice and flat surfaces, ready for painting.

Applying and distributing plaster is typically done with conventional tools such as most commonly flat sheet plaster trowels, where newer alternative tools may also be used, such as more flexible plastic trowels and rubber blade tools such as a plaster squeegee or speedskim. Often, the professional craftsman plastering a wall will first apply a sufficient and generous amount of plaster to any uneven parts of the wall and then distributes and spreads the plaster, e.g., with a suitable trowel. As he shaves off surplus plaster and makes the surface even, the surplus plaster collects on the trowel, he then typically holds a second trowel in his other hand (the left hand, if he is right-handed) to scrape off surplus plaster of the primary trowel onto the secondary (left-hand) trowel. If he needs additional plaster in a location, he can take some of the surplus plaster kept on the secondary trowel with the primary trowel and apply and spread on the location. This, however, always results in loss of some plaster material, which drops off the secondary trowel.

### SUMMARY OF INVENTION

The present invention provides an entirely new tool for keeping a working amount of plaster and which allows the easy shaving-off excess plaster off a trowel or the like tool (scraper, plaster blade or the like) and also picking up plaster from the tool with a conventional trowel or other plastering tool (scraper or the like). The tool comprises an elongated compartment referred to herein as a trough, for receiving and holding wet plaster material. The trough compartment has convenient straight edges along its long sides configured for quick and easy scraping off plaster from a trowel, scraper or the like. The tool has a grip for holding in the hand and in preferred embodiments the mentioned straight edges (one or both) are configured so as to provide an efficient and comfortable angle for scraping off excess plaster from a trowel, when a user holds the tool in his hand (the other hand from the hand holding the trowel).

The tool of the invention comprises an elongated trough with longitudinal inner walls that extend from the bottom of the trough towards upper edges which are longitudinal straight edges, connected at their distal ends by end walls.

The longitudinal inner walls are substantially flat and extend downwardly towards each other such that the trough has a substantially V-shaped cross-section. Preferably, in such embodiments the V-shaped cross-section has an angle of about 90 degrees or wider, such that plaster material in the trough can be readily scraped up with a trowel or scraper.

Opposite and underneath the trough is a grip such that the tool can be comfortably held by a user's hand and operated.

The tool further comprises at least two feet underneath the trough on which the tool can rest with the trough facing upwardly. The feet are shaped and sized so as to allow a user to put his hand under the grip portion when the tool stands on a flat surface to lift up and hold the tool. The grip preferably extends substantially between the at least two feet.

The grip can in some embodiments comprise a separate part fastened to the main part of the tool, this way the grip can be made from a suitable material which is in some embodiments selected from plastic (which can be a different plastic than the main part of the tool in case the main part is of plastic), rubber, silicon, leather, and synthetic leather. The grip portion material should provide a comfortable grip and preferably a desired level of friction (“non-slip” surface) and also be easy to dean.

The main part of the tool comprising at least the trough and the longitudinal straight edges is preferably made from a plastic material. In some embodiments at least the inner walls of the trough are from a material and configured so that the surfaces of the inner walls are at least partially hydrophobic, such as wet plaster (water mixed) has low adherence to the surfaces. The at least two feet are preferably part of the same piece but may also be formed from separate pieces from the same or other material and attached to the main piece.

The longitudinal edges are key elements of the tool, as they are formed to accommodate quick and comfortable scraping off excess plaster from a trowel or the like tool, which excess material is collected in the trough.

In one embodiment, the straight edges are parallel and run horizontal along the length axis of the tool, as it stands on its feet. However, in preferred embodiments, at least one of the edges and preferably both are slanted, preferably such that the slanted edge has an angle from horizontal in the range from about 3° to about 10°, more preferably in the range from about 3° or from about 4° or from about 4.5°, to about 7° or to about 6° or to about 5°, such as about 4° or about 4.5° or about 4.7° or about 5° or about 6°.

Preferably, the tool has at least one slanted edge with downwardly left-descending edge, meaning that when viewing the side of the tool such that the mentioned slanted edge faces the viewer, the edge is slanted downwardly from right to left. This orientation of the edge is found to be particularly beneficial for a user holding the tool in his left hand and a trowel in his right hand, when he scrapes off plaster from the trowel with the edge of the tool (i.e., a right-handed user). However, for a left-handed user the opposite holds true, and thus in some embodiments, at least one edge is a right-descending edge such that the edge is slanted downwardly from left to right when the side with said edge is viewed.

In some embodiments both edges are slanted in the same direction, this means that one edge is slanted with a left-descending edge and the other edge is slanted with a right-descending edge. In this embodiment, the tool thus typically has a mirror symmetry in a central x-z plane of the tool. This is beneficial as the tool is then equally suitable for a right-handed user and a left-handed user, but the user must ensure to grip the tool from a particular side (his “correct” side), to have the desired edge (left-descending edge or right-descending edge) facing his other hand as he scrapes off plaster from a trowel held in his other hand.

In some embodiments both edges are left-descending. This embodiment is particularly advantageous for a right-handed user, as no matter from which side he grips the tool, a left-descending edge will face his other hand. In this embodiment, the tool can be made such that the sides and edges have rotational symmetry, meaning that the tool can be rotated (in a x-y plane) and will look the same.

In some other embodiments, both edges are right-descending, meaning that when viewing the side of the tool such that the mentioned slanted edge faces the viewer, the edge is slanted downwardly from left to right. This embodiment is found to be advantageous to left-handed users.

In some embodiments, in particular where the straight edges are oppositely slanted, the bottom of the V-shaped trough forms a straight line that runs horizontally and is at an angle from the x-axis, such as typically in the range of 3-8°, e.g. 3°, 4°, 5°, 6°, 7° or 8°.

In the description and claims herein, when describing structural and geometrical features of the tool with respect to geometric orientation in x-y-z coordinates, the x-axis runs horizontally along the longitudinal direction of the tool, the y-axis runs horizontally orthogonal to the x-axis direction, and the z-axis is the vertical axis.

In some embodiments at least a main portion of the tool, which refers to a portion comprising at least the trough, inner walls of the trough, end walls, and outer walls of the trough and the mentioned straight edges, is formed from plastic i.e. thermoplastic polymer material, e.g. polypropylene, polyethylene (including LLDPE, LDPE and in particular HDPE), polyamide (Nylon), polystyrene, polyurethane, polyvinylchloride, acetal, polyphenylene sulfide, polyesters, and the like. Other polymer materials may as well be used in certain embodiments, such as acrylonitrile butadiene-styrene (ABS) and other copolymers (acetal copolymers). In some embodiments at least the main portion of the tool is made of wood.

As mentioned above, the feet of the tool may be shaped from the same main portion/piece, whereas in other embodiments the feet are formed from separate pieces and attached to the main piece; in such embodiments the feet can be from the same or different material and can be from a plastic material such as any of the above mentioned. In some embodiments the feet may further comprise sole pieces (like soles of a shoe) which are preferably from a suitably soft material and preferably a non-slip material, such as rubber, silicon or the like, the bottom surface of the feet may further have a roughened or patterned surface, to increase friction to a flat surface on which the tool is placed.

### BRIEF DESCRIPTION OF FIGURES

FIG. 1 shows a perspective view of the tool.

FIGS. 2a and 2b shows a side view of the tool.

FIGS. 3a and 3b shows an end view of the tool.

FIG. 4 shows a top view of the tool.

FIG. 5 shows perspective view (photo) of a prototype of the tool.

FIG. 6 shows a photo of a prototype of the tool lying on its side.

FIG. 7 shows a perspective view of the tool turned upside down.

### DETAILED DESCRIPTION

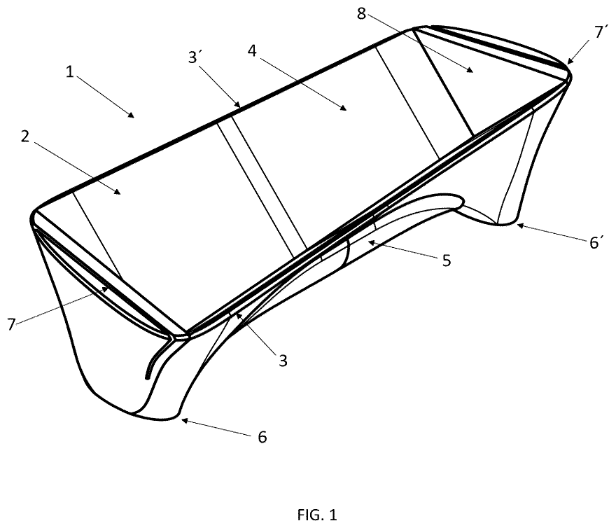

FIG. 1 shows a perspective view of and embodiment of the tool (1). The trough (2) is formed by longitudinal inner walls (4,4′) that extend downwardly towards each other, forming a V-shaped cross-section. Longitudinal straight edges (3,3′) extend along the top edges of the inner walls (4,4′). End walls (8) close off the short ends of the trough. A grip (5) from a non-slip material (such as synthetic leather or rubber) is fastened on the tool, beneath the trough. The feet (6,6′) extend below the grip, such that a user can put his hand under the grip to grip and lift the tool. Two slits (7,7′) are arranged one in each distal end of the tool, adjacent the end walls (8), the slits (7,7′) are formed to fit trowels or scrapers.

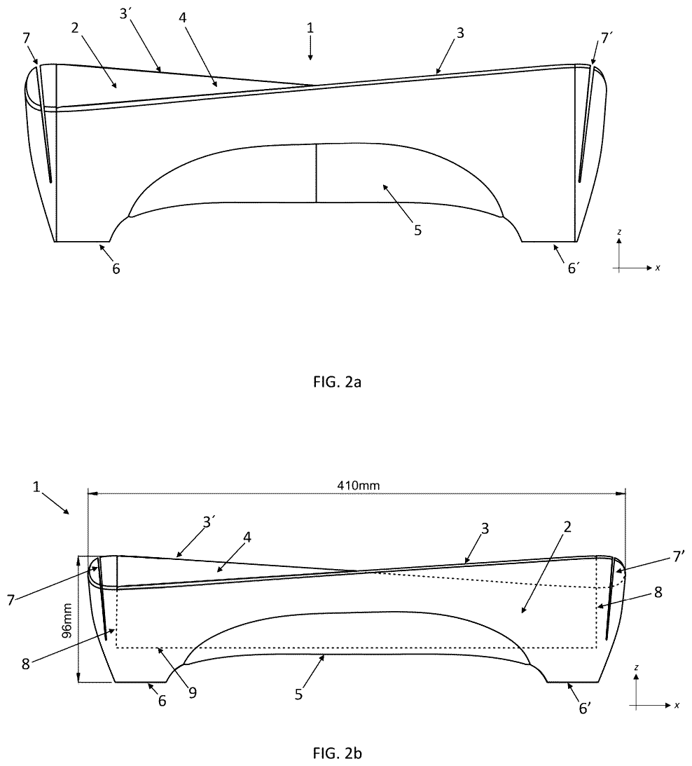

FIGS. 2a and 2b show a sideview of the tool (1). This view clearly shows the slanting form of the edges (3,3′) which in this embodiment are both left-descending, meaning that the from edge (3) (in the sideview) is slanted downwardly from right to left. The back edge (3′) farther away is slanted in the opposite direction, but if the tool is turned 180 degrees in the x-y plane, it would look the same. In other words, the tool in this embodiment has rotational symmetry around a central vertical axis. FIG. 2b shows with dotted lines the shape of the V-shaped trough formed by the end walls (8) that extend to the bottom (9). Note that the indicated dimensions are non-limiting and only indicate a particular embodiment.

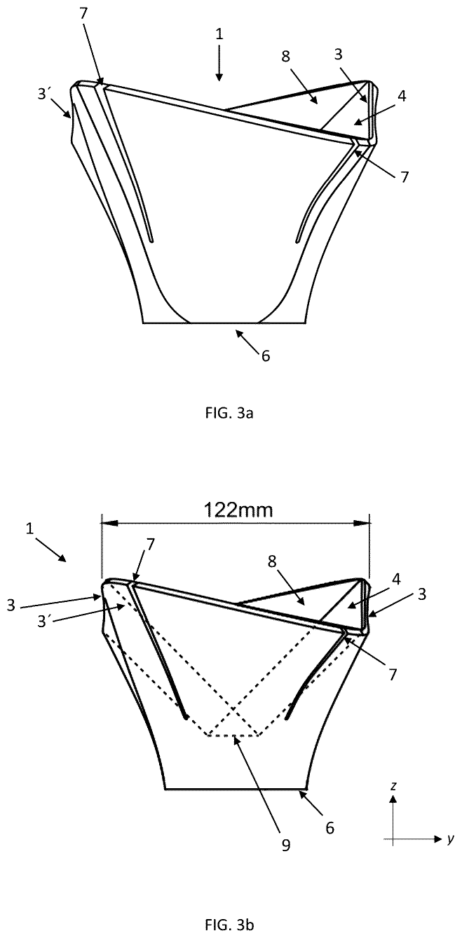

FIGS. 3a and 3b show an end view of the tool (1). As is seen, the end edges should also be slanted to joint together the side edges (3,3′). This view shows also the slit (7) for fitting a scraper or trowel. FIG. 3b show with dotted lines the shape of the V-shaped trough. It can be seen how in this embodiment the bottom line (9) is not parallel with the longitudinal axis of the tool (the x-axis), as the far-end bottom in this figure is farther to the left than the end of the bottom which is nearer. The indicated dimensions are non-limiting and only indicate a particular embodiment.

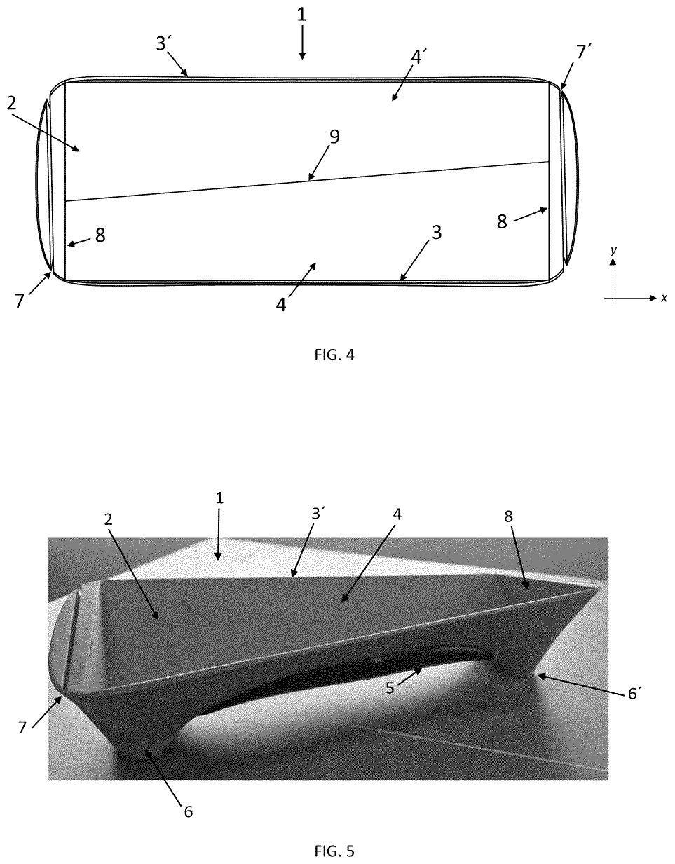

FIG. 4 shows a top view of the tool (1). This view shows how the inner walls (4,4′) of the trough (2) meet at the bottom, forming a bottom line (9) that runs diagonally along the trough bottom, at an angle to the longitudinal axis of the tool (the x-axis).

FIG. 5 is a perspective view photo of a prototype of the tool (1).

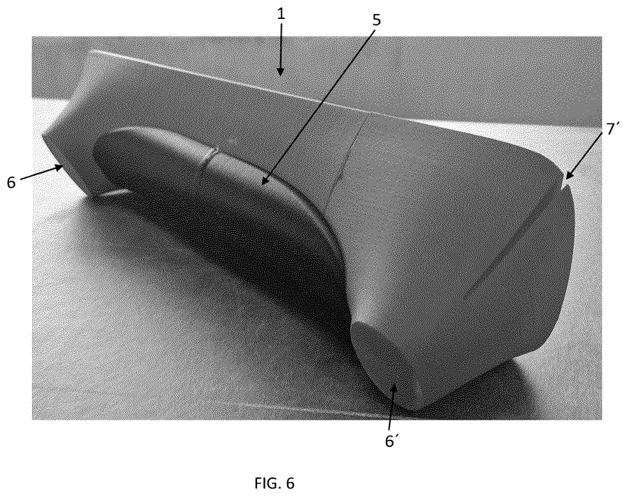

FIG. 6 is a perspective view photo of a prototype of the tool (1) lying on its side, to show the grip (5) and feet (6,6′) better.

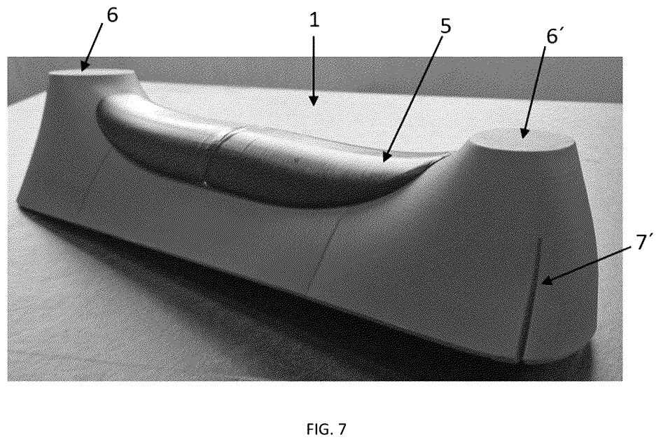

FIG. 7 is a perspective view photo of a prototype of the tool (1) lying upside down.

1. A tool for keeping plaster and scraping excess plaster off a trowel or the like tool, comprising
an elongated trough with longitudinal inner walls that extend to respective longitudinal straight edges connected by two end walls,
a grip portion underneath the trough,
at least two feet underneath the trough on which the tool can rest with the trough facing upwardly, wherein said two longitudinal inner walls extend downwardly towards each other, such that the trough has a substantially V-shaped cross-section.

2. The tool according to claim 1, wherein said grip portion comprises a material selected from plastic, rubber, silicon, leather, and synthetic leather.

3. The tool according to claim 1, wherein said two edges run parallel in the in the x-y plane, where the x-axis runs horizontally along the longitudinal direction of the elongated trough and the y-axis runs horizontally orthogonal to the x-axis,
wherein at least one of said edges is slanted vertically.

4. The tool according to claim 3, wherein said at least one edge is slanted from horizontal by an angle in the range from about 3° to about 10° and preferably in the range from about 4° to about 6°.

5. The tool according to claim 3, wherein said two edges are oppositely slanted vertically and both edges are left-descending, such that each edge is slanted downwardly from right to left when viewing the side of the edge in side-view.

6. The tool according to claim 3, wherein said two edges are oppositely slanted vertically and both edges are right-descending, such that each edge is slanted downwardly from left to right when viewing the side of the edge in side-view.

7. The tool according to claim 3, wherein said two edges are symmetrically slanted, with rotational symmetry around the center point of the tool.

8. The tool according to claim 3, wherein said two edges are symmetrically slanted, with rotational symmetry around the center point of the tool.

9. The tool according to claim 3, wherein said two edges (3,3′) are symmetrically slanted, with mirror symmetry across a x-z center plane of the tool, where the x-axis runs horizontally along the longitudinal direction of the elongated trough and the z-axis is vertical.

10. The tool according to claim 1, wherein the bottom of said V-shaped trough forms a straight line that runs horizontally and is at an angle from the x-axis of the tool in the range of 3-8°.

11. The tool according to claim 1, comprising at least one slit arranged distally of either or both of said end walls, to fit and hold a plaster scraper.

12. The tool according to claim 1, comprising a main portion of a plastic material selected from polypropylene, polyethylene (including LLDPE, LDPE and in particular HDPE), polyamide (Nylon), polystyrene, polyurethane, polyvinylchloride, acetal, polyphenylene sulfide, polyesters, acrylonitrile butadiene-styrene (ABS), and acetal polyesters.

13. The tool according to claim 1 wherein said edges and trough have a length in the range from about 20 to about 60 cm and preferably a length in the range from about 25 to about 40 cm.
